(19) United States
(12) Patent Application Publication
(10) Pub. No.: US 2011/0149831 A1
(43) Pub. Date: Jun. 23, 2011

(54) APPARATUS AND METHOD FOR MANAGING MULTIMEDIA BROADCAST MULTICAST SERVICE BEARER

(75) Inventors: Eun Hee HYUN, Daejeon (KR); HoChoong CHO, Daejeon (KR); Sang Ho LEE, Daejeon (KR)

(73) Assignee: Electronics and Telecommunications Research Institute, Daejeon (KR)

(21) Appl. No.: 12/974,691

(22) Filed: Dec. 21, 2010

(30) Foreign Application Priority Data
Dec. 21, 2009 (KR) 10-2009-0127949

(51) Int. Cl. H04H 20/71

(52) U.S. Cl. 370/312

(57) ABSTRACT

Provided is an MBMS bearer setting managing method and apparatus. The MBMS bearer setting managing method configures an MBMS bearer context including information corresponding to the single service and information corresponding to the plurality of sessions, and manages the MBMS bearer setting based on the information corresponding to the single service and the information corresponding to each of the plurality of sessions.

### CROSS-REFERENCE TO RELATED APPLICATION

This application claims the benefit of Korean Patent Application No. 10-2009-0127949, filed on Dec. 21, 2009, in the Korean Intellectual Property Office, the disclosure of which is incorporated herein by reference.

### BACKGROUND

1. Field of the Invention

The present invention relates to a multimedia broadcast and multicast service (MBMS) bearer setting managing method and apparatus, and more particularly, to configuring and managing of an MBMS bearer context that may set an MBMS bearer for each session to support an MBMS where a single service is composed of a plurality of different sessions.

2. Description of the Related Art

Service technologies transmitting multimedia contents based on a broadcast scheme or a multicast scheme over a mobile communication network has been introduced and realized. For example, a 3^{rd} generation partnership project (3GPP) mobile communication network provides an evolved multimedia broadcast and multicast service (EMBMS), and the EMBMS may transmit, to user terminals, a multimedia contents packet obtained from a content provider (CP) or from an multicast broadcast source (MB source) server via the mobile communication network based on the broadcasting scheme or the multicasting scheme. Specifically, a system may transmit corresponding contents once, and a plurality of users may simultaneously receive the contents.

When a single service includes a plurality of sessions while the EMBMS is provided, an MBMS bearer setting procedure may be performed for each session by a multimedia broadcast and multicast service (MBMS) session start request. In this case, a start time and a stop time may be different for each session, a feature of contents to be transmitted may be different for each session, and a capability of each MBMS bearer, a Quality of Service (QoS), and the like may be different for each session and thus, an MBMS bearer may need to be set based on the described features and a bearer context may need to be appropriately managed based on the described conditions.

Accordingly, there is a need for an MBMS bearer setting managing method and apparatus that may set an MBMS bearer based on features for each session, when a single service includes a plurality of sessions.

### SUMMARY

According to an aspect of the present invention, there is provided a multimedia broadcast and multicast service (MBMS) bearer setting managing method to provide a single service using a plurality of sessions, the method includes configuring an MBMS bearer context including information corresponding to the single service and information corresponding to each of the plurality of sessions, and managing the MBMS bearer setting based on the information corresponding to the single service and the information corresponding to each of the plurality of sessions.

The information corresponding to each of the plurality of sessions may include a number of sessions corresponding to the single service and session identifiers with respect to the plurality of sessions.

The information corresponding to each of the plurality of sessions may further include state information with respect to the plurality of sessions, bearer capability information, and quality of service (QoS) information.

The state information with respect to the plurality of sessions, the bearer capability information, and the QoS information may include a feature of data contents transmitted by each session.

The managing may manage each of the plurality of sessions to store different information.

The managing may combine a service identifier with respect to the single service and the session identifiers with respect to the plurality of sessions to manage an MBMS bearer setting.

According to an aspect of the present invention, there is provided an MBMS bearer setting managing apparatus to provide a single service using a plurality of sessions, the apparatus may provide a bearer context managing unit to configure an MBMS bearer context including information corresponding to the single service and information corresponding to each of the plurality of sessions, and a bearer setting managing unit to manage the MBMS bearer setting based on the information corresponding to the single service and the information corresponding to each of the plurality of sessions.

According to an aspect of the present invention, there is provided an MBMS service providing system, the system includes an evolved broadcast multicast service center (eBM-SC) node to perform management of an MBMS, an MBMS1 node to perform a session control function in a mobile communication network, an MBMS2 node to perform a traffic control and transmission path managing function, and an eNodeB node to perform transmission and reception of a signal with a plurality of terminals and to act as an access point (AP) of the plurality of terminals, and an MBMS bearer context may manage the eBM-SC node, the MBMS1 node, the MBMS2 node, and the eNodeB node, and may include information corresponding to a service and information corresponding to a plurality of sessions composing the service.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an evolved multimedia broadcast and multicast service (EMBMS) providing system based on a 3^{rd} generation partnership project (3GPP) mobile communication network according to an embodiment of the present invention;

FIG. 2 is a diagram illustrating a single service composed of a plurality of sessions in a 3GPP network according to an embodiment of the present invention;

FIG. 3 illustrates an MBMS bearer context according to an embodiment of the present invention;

FIG. 4 is a diagram illustrating a transmission of session-based information between nodes according to an embodiment of the present invention;

FIG. 5 is a flowchart illustrating an MBMS bearer setting managing method according to an embodiment of the present invention; and

FIG. 6 is a block diagram illustrating an MBMS bearer setting managing apparatus according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

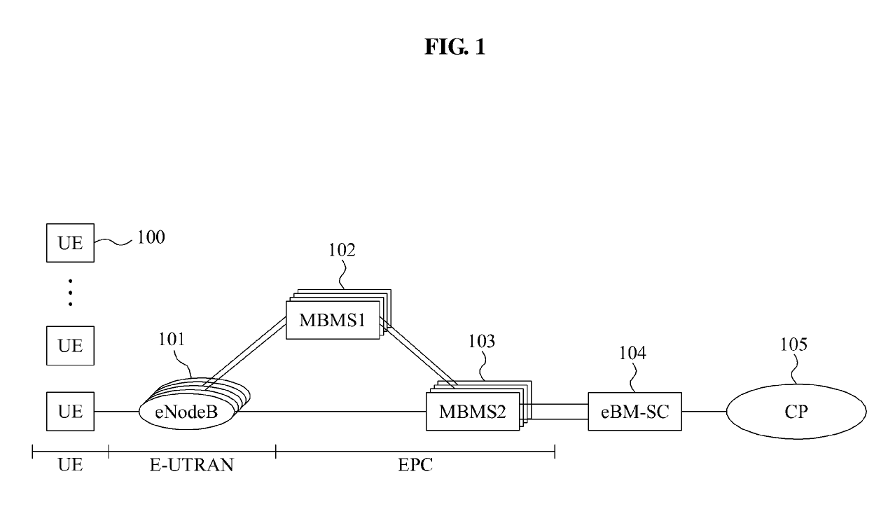

FIG. 1 illustrates an evolved multimedia broadcast and multicast service (EMBMS) providing system based on a 3^{rd} generation partnership project (3GPP) mobile communication network according to an embodiment of the present invention.

Referring to FIG. 1, the 3GPP mobile communication network may include an evolved universal mobile telecommunications network terrestrial radio access network (EUTRAN), an evolved packet core (EPC), and an evolved broadcast multicast service center (eBM-SC) 104, the EUTRAN including a plurality of user equipments (UEs) 100 receiving broadcast multimedia contents packets and a plurality of eNodeBs 101 to perform radio resource management, radio channel setting, and the like for wireless transmission with the plurality of UEs 100, the EPC interoperating with the EUTRAN to control an EMBMS session and performing transmission and reception of a traffic from outside a network, and the eBM-SC 104 being a control system to provide the EMBMS.

Elements of the network may manage a session, and may set and manage a bearer to transmit contents received from a content provider (CP) 105 and thus, may simultaneously transmit multimedia contents to the plurality of UEs 100 existing in a predetermined point in time, by a single transmission.

The plurality of eNodeBs 101 composing the EUTRAN may receive, in a physical layer, uplink signals transmitted from the plurality of UEs 100, and may transmit, in a physical layer, downlink signals to the plurality of UEs 100. The plurality of eNodeBs 101 may perform transmission and reception of signals with the plurality of UEs 100, and may perform as an Access Point (AP) of the plurality of UEs 100. In this case, the plurality of eNodeBs 101 may manage radio resources based on a cell unit and thus, may communication with the plurality of UEs 100 existing in the corresponding cell via a radio channel.

The EPC may include a network element MBMS1 102 and an MBMS2 103. In this case, the MBMS2 103 may perform a session control function in a mobile communication network to support an EMBMS. The MBMS2 103 may manage an MBMS traffic path, may transmit traffic via a predetermined path, and may perform an MBMS gateway function. Specifically, the EPC may interoperate with the plurality of eNodeBs 101 of the EUTRAN to set an MBMS multicast bearer for the EMBMS and thus, may provide a function of transmitting contents via the MBMS multicast bearer.

The eBM-SC 104 may be a node to control an EMBMS, and may be essential to provide the EMBMS as a functional element in a W-CDMA system. The eBM-SC 104 may be a main body of managing and controlling the EMBMS, and may manage an MBMS session start procedure and an MBMS session stop procedure to manage a start and a stop of all types of EMBMS including the broadcast EMBMS and the multicast EMBMS. In this case, the plurality of eNodeBs 101 may perform an EMBMS bearer setting to transmit contents, and each bearer may be set to use radio resources based on a bearer transmission capability, QoS information, and the like according to a feature of the contents. A multicast service may receive a multicast joins from the plurality of UEs 100 and may configure a multicast tree that may transmit data of a corresponding service to the plurality of UEs 100. The multicast tree may be configured based on an MBMS Activation procedure. In this case, in the MBMS Activation procedure, an upper node may register a path connected to a corresponding UE to go through lower nodes, and each of the eBM-SC 104, the MBMS2 103, the MBMS1 102, the plurality of eNodeBs 101, and the plurality of UEs 100 may generate a bearer context with respect to the EMBMS.

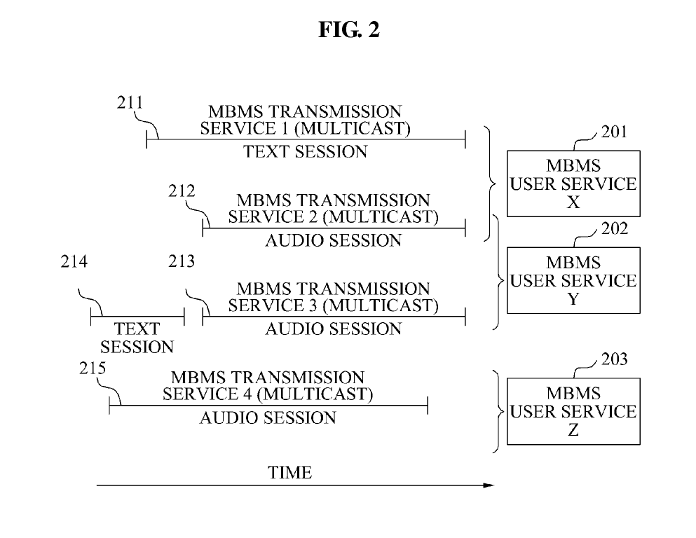

FIG. 2 illustrates a single service composed of a plurality of sessions in a 3GPP network according to an embodiment of the present invention.

FIG. 2 defines an EMBMS in a 3GPP network, and each of the MBMS user service X 201 and the MBMS user service Y 202 may be composed of a plurality of sessions. In a broadcast service, data may be transmitted through a single bearer generated by a single session to all areas and thus, a single session 215 may be used for a single service, such as an MBMS user service Z 203.

The MBMS user service X 201 may be composed of a text session 211 transmitting text data and an audio session 212 transmitting audio data. The MBMS user service Y 202 may be composed of the audio session 212 transmitting audio data, a video session 213 transmitting video data, and another text session 214 transmitting text data after the video session is completed. Each session may perform an MBMS session start procedure at a point in time where the corresponding session needs to be started by the eBM-SC, and all nodes including the eBM-SC may configure an MBMS bearer context to designate a path through which the corresponding service is to be transmitted, based on an MBMS Activation procedure.

Features of contents to be transmitted by each of sessions composing the single service may be different from each other as illustrated in FIG. 2. For example, each of the sessions may have different starts and different stops and thus, two or more sessions may need to be simultaneously activated or only a session may need to be activated at an arbitrary point in time. Each of the sessions may have different transmission rates used for transmitting the corresponding contents, or may have different QoS information. Radio channels may be allocated based on the different features and thus, the radio resources may be effectively used. Therefore, the information may be stored and managed for each session.

Accordingly, information associated with each session may be independently stored and managed in the MBMS bearer context and thus, the radio resource may be effectively used.

An embodiment of the present invention may be applied to a service composed of two or more sessions, such as the MSMS user service X 201 and the MBMS user service Y 202, and the embodiment of the present invention may also be applied to a broadcast service when a single broadcast service is composed of a plurality of service sessions.

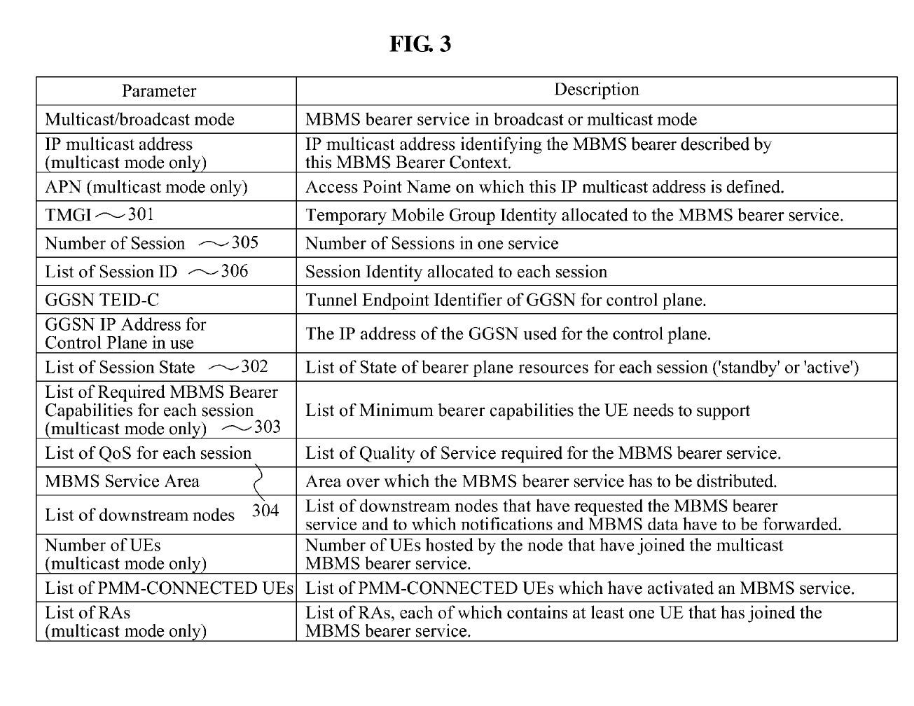

FIG. 3 illustrates an MBMS bearer context according to an embodiment of the present invention.

FIG. 3 illustrates the MBMS bearer context where a session identifier field 306 indicating a session identifier defined for each session and a session number field 305 indicating a number of sessions composing the corresponding service are added. Information stored in the MBMS bearer context may include information depending on an MBMS and information depending on a session. A state information field 302, a bearer capability information field 303, a QoS information field 304, and the like among the information may include a feature of data contents to be transmitted based on a session, and other information may be applied to all sessions composing the corresponding service based on the service. The session number field 305 indicating the number of sessions composing the corresponding service and the session identifier field 306 according to the number of sessions are added in the MBMS bearer context, and the state information field 302, the bearer capability information field 303, and the QoS information field 304 may be stored in the MBMS bearer context, based on each session identifier. The MBMS bearer context may be managed by each of an eBM-SC, an MBMS2, an MBMS1, and an eNodeB, and procedures to be processed based on a session may search for unique information by combining a newly added session identifier 306 and a temporary mobile group identity (TMGI) 301 used as a service identifier. The described session-based information may be utilized for a session start and stop procedure and a radio resource allocating for the MBMS bearer setting.

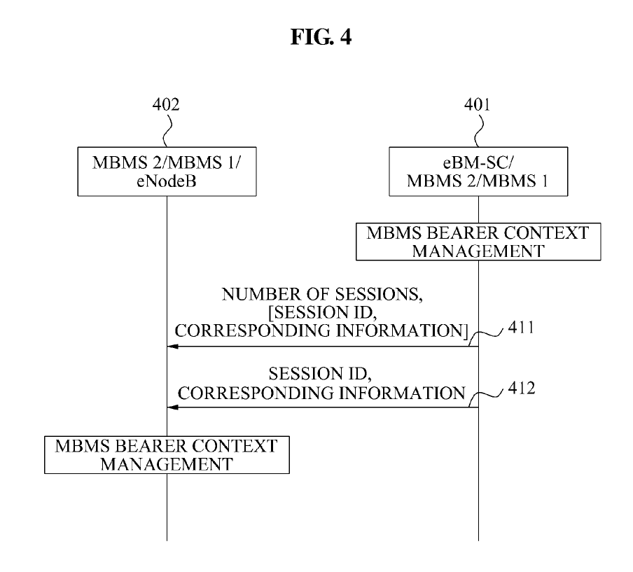

FIG. 4 illustrates a transmission of session-based information between nodes according to an embodiment of the present invention.

Referring to FIG. 4, the transmission may be performed between an upper node 402 including an MBMS2, an MBMS1, and an eNodeB, and a lower node 401 including eBM-SC, the MBMS2, and the MBMS 1, and may be performed between an eBM-SC node and an MBMS2 node, between the MBMS2 node and an MBMS1 node, and between the MBMS1 and an eNodeB, in the same manner.

A session identifier may be generated when corresponding service information is registered in the eBM-SC. Bearer capability information and QoS information may also be determined when a service is defined. The session identifier is a value provided by a service provider or a CP when the corresponding service information is input in a service information management database by an eBM-SC, and the value may be input by the eBM-SC or a mobile communication network operator. In the eBM-SC, the input data may be configured as an MBMS bearer context by an MBMS bearer information management module, and may be transmitted to the MBMS2, which is a lower node, at an appropriate point in time.

For example, during an MBMS Activation procedure, the eBM-SC may transmit MBMS bearer capability information to an MBMS authorization response and an MBMS registration response message. In an example 411 where a single procedure is defined for each service, to transmit information associated with all sessions through the signal procedure, a number of sessions may be written in a single message and session identifiers and the corresponding information may be transmitted, a number of session identifiers being the same as the number of sessions.

In another example 412 where a procedure, such as an MBMS session start request, is defined for each session, a corresponding session identifier and information associated with a corresponding session may be transmitted. In this case, when a procedure with respect to sessions composing the same service is performed, a lower node may search for an MBMS bearer context corresponding to the same service, and may maintain the MBMS bearer context to store information for each session.

Each node may utilize information for each session when setting an MBMS bearer to which data is transmitted. For example, when an eNodeB allocates radio resources for an MBMS bearer during a MBMS session start procedure, the radio resources may be appropriately allocated based on QoS information of the corresponding session. When the service is performed, an MBMS activation procedure may include a point in time of determining a bearer capability between a terminal and an eNodeB, and the MBMS activation procedure may be performed based on a service unit.

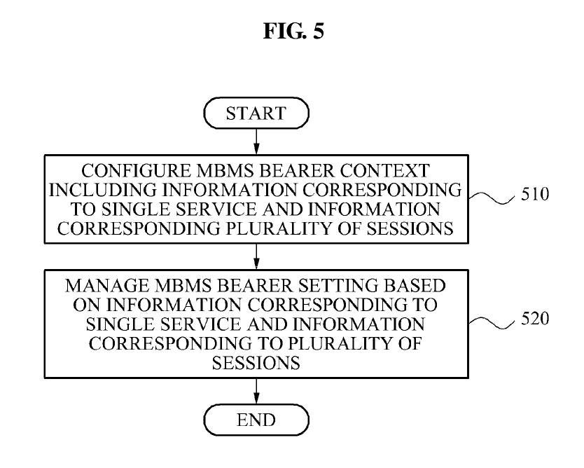

FIG. 5 illustrates an MBMS bearer setting managing method according to an embodiment of the present invention.

Referring to FIG. 5, an MBMS bearer context including information corresponding to a single service and information corresponding to a plurality of session may be configured in operation 510. Specifically, information determined based on a single service unit and information determined based on a session unit may be respectively stored and managed. Therefore, when a single service is composed of a plurality of sessions, information determined based on a session unit may be stored and managed for each session and thus, information different for each session may be relatively accurately applied.

For example, information corresponding to each of the plurality of sessions may include information associated with a number of the plurality of sessions corresponding to the single service and session identifiers corresponding to the plurality of sessions. The information corresponding to each of the plurality of sessions may further include state information with respect to the plurality of sessions, bearer capability information, and QoS information. Each of the sessions may have a different transmission rate, QoS information, and the like used for transmitting a corresponding contents and thus, information may be stored and managed for each session.

In operation 520, an MBMS bearer setting is managed based on the information corresponding to the single service and the information corresponding to the plurality of sessions. The MBMS bearer setting may be managed by combining a service identifier with respect to the single service and the session identifiers with respect to the plurality of sessions.

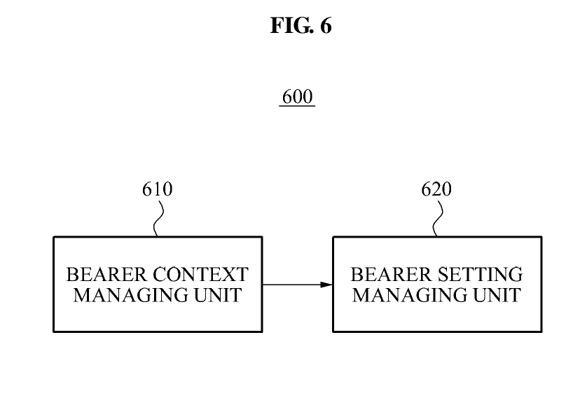

FIG. 6 illustrates an MBMS bearer setting managing apparatus 600 according to an embodiment of the present invention.

Referring to FIG. 6, the MBMS bearer setting managing apparatus 600 may include a bearer context managing unit 610 and a bearer setting managing unit 620.

The bearer context managing unit 610 may configure an MBMS bearer context including information corresponding to a single service and information corresponding to each of the plurality of sessions. In this case, the information corresponding to each of the plurality of sessions may include at least one among information associated with a number of sessions corresponding to the single service, information associated with identifiers corresponding to the plurality of sessions, state information with respect to the plurality of sessions, bearer capability information, and QoS information.

A bearer setting managing unit 620 may manage an MBMS bearer setting based on the information corresponding to the single service and information corresponding to the plurality of sessions.

The information may be managed and stored in the MBMS bearer context based on a combination of a service identifier and session identifiers, and information corresponding to each session may be stored, an amount of information being the same as a number of sessions, and thus, a feature of each session may be included in MBMS bearer and may effectively utilize radio resources.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of managing a multimedia broadcast and multicast service (MBMS) bearer setting to provide a single service using a plurality of sessions, the method comprising:
configuring an MBMS bearer context including information corresponding to the single service and information corresponding to each of the plurality of sessions; and
managing the MBMS bearer setting based on the information corresponding to the single service and the information corresponding to each of the plurality of sessions.

2. The method of claim 1, wherein the information corresponding to each of the plurality of sessions includes a number of sessions corresponding to the single service and session identifiers with respect to the plurality of sessions.

3. The method of claim 2, wherein the information corresponding to each of the plurality of sessions further includes state information with respect to the plurality of sessions, bearer capability information, and quality of service (QoS) information.

4. The method of claim 3, wherein the state information with respect to the plurality of sessions, the bearer capability information, and the QoS information include a feature of data contents transmitted by each session.

5. The method of claim 1, wherein the managing manages each of the plurality of sessions to store different information.

6. The method of claim 1, wherein the managing combines a service identifier with respect to the single service and the session identifiers with respect to the plurality of sessions to manage an MBMS bearer setting.

7. An apparatus of managing an MBMS bearer setting to provide a single service using a plurality of sessions, the method comprising:
a bearer context managing unit to configure an MBMS bearer context including information corresponding to the single service and information corresponding to each of the plurality of sessions; and
a bearer setting managing unit to manage the MBMS bearer setting based on the information corresponding to the single service and the information corresponding to each of the plurality of sessions.

8. The apparatus of claim 7, wherein the information corresponding to each of the plurality of sessions includes a number of sessions corresponding to the single service and session identifiers with respect to the plurality of sessions.

9. The method of claim 8, wherein the information corresponding to each of the plurality of sessions further includes state information with respect to the plurality of sessions, bearer capability information, and QoS information.

10. The apparatus of claim 9, wherein the state information with respect to the plurality of sessions, the bearer capability information, and the QoS information include a feature of data contents transmitted by each session.

11. The apparatus of claim 7, wherein the bearer setting managing unit manages each of the plurality of sessions to store different information.

12. The apparatus of claim 7, wherein the bearer setting managing unit combines a service identifier with respect to the single service and the session identifiers with respect to the plurality of sessions to manage an MBMS bearer setting.

13. A system of providing an MBMS service, the system comprising:
an evolved broadcast multicast service center (eBM-SC) node to perform management of an MBMS;
an MBMS1 node to perform a session control function in a mobile communication network;
an MBMS2 node to perform a traffic control and transmission path managing function; and
an eNodeB node to perform transmission and reception of a signal with a plurality of terminals and to act as an access point (AP) of the plurality of terminals,
wherein an MBMS bearer context manages the eBM-SC node, the MBMS1 node, the MBMS2 node, and the eNodeB node, and includes information corresponding to a service and information corresponding to a plurality of sessions composing the service.

14. The system of claim 13, wherein the information corresponding to the plurality of sessions include a number of the plurality of sessions and session identifiers of the plurality of sessions.

15. The system of claim 14, wherein the information corresponding to the plurality of sessions further include the state information with respect to the plurality of sessions, the bearer capability information, and the QoS information.
